(19) United States
(12) Patent Application Publication
(10) Pub. No.: US 2010/0121009 A1
(43) Pub. Date: May 13, 2010

(54) CATALYST SYSTEM FOR OLEFIN POLYMERIZATION PROCESS FOR PRODUCING IT AND A PROCESS FOR THE POLYMERIZATION OF ALPHA-OLEFINS USING THE CATALYST SYSTEM

(75) Inventors: Marc Oliver Kristen, Kelkheim (DE); Rolf Mülhaupt, Freiburg (DE); Gil Scheuermann, Freiburg (DE); Alexander Kurek, Freiburg (DE)

Correspondence Address: LyondellBasell Industries, 3801 WEST CHESTER PIKE, NEWTOWN SQUARE, PA, 19073, US

(73) Assignee: BASELL POLYOLEGINE GMBH, Wesseling (DE)

(21) Appl. No.: 12/451,207

(22) PCT Filed: May 5, 2008
(86) PCT No.: PCT/EP2008/003579

§ 371 Date: Oct. 30, 2009

Related U.S. Application Data
(60) Provisional application No. 60/965,427, filed on Aug. 20, 2007.

(30) Foreign Application Priority Data
May 8, 2007 (DE) 10 2007 022 052.0

(51) Int. Cl. C08F 4/12; B01J 37/30

(52) U.S. Cl. 526/120; 502/11

(57) ABSTRACT

The invention relates to a catalyst system comprising a support in which transition metal cations or uncharged transition metal atoms are distributed. The system further comprises one or more separately added ligands which are capable of forming a coordinate or covalent bond with the transition metals. The catalyst system is produced by replacing metal ions present in a support by transition metal ions. The transition metal ions can optionally be reduced. One or more ligands which are capable of forming a coordinate or covalent bond with the transition metal or metals are subsequently added. The catalyst is used for the polymerization of olefins.

The invention relates to a catalyst system for olefin polymerization, a process for producing this catalyst system and a process for the polymerization of α-olefins using the catalyst system.

Catalyst systems for the polymerization of olefins have been known for a long time both in supported form and in unsupport form. To improve the physico-chemical properties of polymers, clay minerals were used early on as fillers. To ensure a very good distribution of the clay minerals in the polymer matrix, processes in which the polymers are prepared in the presence of clay minerals, which function in part as supports for catalysts, have been proposed.

The U.S. Pat. No. 4,187,210 describes, for example, a transition metal catalyst which has been applied to the surface of an inorganic filler. The filler simultaneously performs the function of a support. Clay minerals which firstly have to be dehydrated under oxidizing conditions at high temperatures are used as fillers. However, the catalytically active transition metal compounds are generally not sufficiently stable for application to these clay minerals.

For this reason, other processes in which the penetration of the filler into the polymer matrix is improved by widening the layer spacings have been developed. Thus, DE 198 46 314 A1 discloses, for example, a process for producing nanocomposites in which the layer spacings of the phyllosilicates have been widened by reaction with organic hydrophobicizing agents. Olefins are then polymerized by means of transition metal catalysts in the presence of the phyllosilicates.

On the other hand, WO02/051889 again proposes a catalyst system comprising a supported catalyst which comprises a polymer, a phyllosilicate and a transition metal compound. The catalyst system also comprises an aluminoxane. Owing to the hydrophilicity of the phyllomineral, this is treated with a polymer comprising polar groups before the transition metal compound is applied.

However, all these processes are very complicated.

It was therefore an object of the present invention to provide a catalyst system which is simple to produce and ensures a very uniform distribution of the catalyst in the polymerization mixture and when employed for producing nanocomposites leads to a nanodisperse distribution of the filler in the polymer.

This object is achieved by a catalyst system which comprises a) a support in which cations or uncharged metal atoms of one or two or more transition metals of group 4, 5, 6, 7, 8, 9 or 10 of the Periodic Table of the Elements are distributed and b) one or more separately added ligands which are capable of forming a coordinate or covalent bond with the transition metals.

Preferred supports are phyllominerals, particularly preferably phyllosilicates, whose ions have been replaced by cations of one or two or more transition metals of group 4, 5, 6, 7, 8, 9 or 10 of the Periodic Table of the Elements, with the metal ions optionally being able to be reduced.

Phyllosilicates suitable for the purposes of the invention are both natural and synthetic phyllosilicates. The term phyllosilicates generally refers to silicates in which SiO₄ tetrahedra are joined in infinite two-dimensional networks. The empirical formula of the anion is (Si₂O₅²⁻)ₙ. The individual layers are bound to one another by the cations located between them; in the naturally occurring phyllosilicates, sodium, potassium, magnesium, aluminum or/and calcium are present as cations.

Possible phyllosilicates are natural or synthetic smectite clay minerals, in particular montmorillonite, saponite, beidelite, nontronite, hevtorite, sauconite and stevensite, and also bentonite, vermiculite and halloysite. Preference is given to montmorillonite.

The phyllosilicate montmorillonite, for example, generally corresponds to the formula:

Al₂[(OH)₂/Si₄O₁₀].nH₂O, where part of the aluminum can have been replaced by magnesium. The composition varies depending on the silicate deposit. A preferred composition of the phyllosilicate corresponds to the formula: (Al_{3.15}Mg_{0.85})Si_{8.00}O₂₀(OH)₄X_{11.8}.nH₂O, where X is an exchangeable cation, in general sodium or potassium. The amount of exchangeable metal ions is usually reported in milliequivalents (meq) per 100 g of phyllosilicate and referred to as ion exchange capacity.

The phyllosilicates used preferably have a cation exchange capacity in the range from 50 to 200 meq/100 g (milliequivalents per 100 gram). Such phyllosilicates which can be used are described, for example, in A. D. Wilson, H. T. Posser, Developments in Ionic Polymers, London, Applied Science Publishers, Chapter 2, 1986. Synthetic phyllosilicates are, for example, obtained by reaction of natural phyllosilicates with sodium hexafluorosilicate. Synthetic phyllosilicates are commercially available from CO-OP Chemical Company, Ltd., Tokyo, Japan.

The cations of the phyllosilicates are replaced by suitable transition metal ions of group 4, 5, 6, 7, 8, 9 or 10 of the Periodic Table of the Elements. Ions of the metals of groups 6, 8 and 10 of the Periodic Table of the Elements, preferably Cr, Fe, Ni and Pd and combinations of these, are particularly suitable. The metal cations can optionally and particularly preferably be reduced to uncharged metal atoms. Thus, the support matrix preferably comprises Cr³⁺, Fe³⁺, Ni²⁺, the combination of Ni²⁺ and Pd²⁺ or very particularly preferably after the reduction of the ions Ni⁰, Cr⁰, Fe⁰ or the combination of Ni⁰ and Pd⁰.

The cation exchange makes it possible to obtain a uniform nanodisperse distribution of the transition metal ions. In the case of hybrid catalysts, it has been found that a cation of one of the two elements preferably takes up the position of the original cation which is replaced. The cations, or after reduction the atoms, of the two elements are therefore ideally distributed in the support matrix.

The above-described untreated and treated phyllosilicates are usually used in the form of a dispersion for the ion exchange. As dispersion media, preference is given to using polar liquids, particularly preferably water. The dispersions are preferably heated under reflux and can be homogenized further with the aid of ultrasound. The dispersions are subsequently mixed with a solution of the modifying agent, preferably in the same solvent, e.g. water. This is followed by centrifugation, advantageously at stirring speeds in the range 5000 to 20 000 rpm, particularly preferably from 12 000 to 16 000 rpm, for a period of from 1 minute to 3 hours, preferably for a period of from 1 to 3 hours, and subsequent filtration. The steps of dispersion, centrifugation and filtration are repeated a number of times and the residue is subsequently dried.

In the polymerization process, the modified phyllosilicates are used as dispersion. Possible dispersion media are inert nonpolar aliphatic and aromatic liquids. Suitable dispersion media are, for example, aliphatic hydrocarbons such as heptane or i-octane, aromatic hydrocarbons such as benzene, toluene or xylene, halogenated hydrocarbons such as chloroform or dichloromethane or mixtures of the compounds mentioned.

The phyllosilicate dispersions can, for example, be produced directly in the polymerization vessel. However, they can also be produced separately and then either initially placed in the reaction vessel or added at any desired point in time before addition of the catalyst compounds.

The ligand can be initially placed in the reaction vessel together with the phyllosilicate or can be added subsequently. It is usually added in excess (2-6 molar equivalents based on the transition metal).

The process of the invention makes it possible to (co)polymerize a wide variety of C₂₋₂₀-1-alkenes, in particular C₂-C₁₂-1-alkenes, to form polyolefins. Apart from ethene or propene, 1-alkenes such as 1-butene, 1-pentene, 1-hexene, 1-heptene or 1-octene and also 1-decene or 1-dodecene are possible. Of course, 1-alkenes also include aromatic monomers having a vinylic double bond, i.e. vinylaromatic compounds such as styrene alpha-methylstyrene. It is also possible to use any mixtures of C₂-C₂₀-1-alkenes or mixtures of 1-alkenes with vinylaromatic compounds, e.g. styrene with ethene or higher 1-alkenes such as 1-butene or 1-octene. Preference is given to employing ethene or propene or mixtures thereof. The process of the invention for producing polyolefin nanocomposites enables both homopolymers such as polyethylene or homopropylene and copolymers, for example poly(ethene-co-1-butene), to be obtained.

In a preferred embodiment, C₂₋₂₀-1-alkenes and/or vinylaromatic compounds are polymerized in the presence of a dispersion of one or more phyllosilicates modified with transition metals in a nonpolar aliphatic or aromatic dispersion medium and a ligand.

Preferred ligands are bidentate or tridentate chelating ligands of the formula (I)

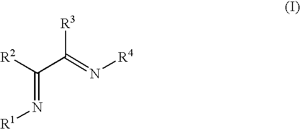

where
R¹ is hydrogen, a straight-chain or branched C₁₋₁₀-alkyl which may be halogenated or perhalogenated, a C₃₋₁₀-cycloalkyl which may be substituted by a straight-chain or branched C₁₋₁₀-alkyl or is C₆₋₁₄-aryl which may be substituted by one or more substituents selected independently from among C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, halogen, NR¹¹₂, OR¹¹, SiR¹²₃ and halogens, where two vicinal substituents may also be joined to form a five-, six- or seven-membered ring and two vicinal substituents may also be joined to form a five-, six- or seven-membered heterocycle comprising at least one atom from the group consisting of N, P, O and S,
R² and R⁶ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where the organic radicals R^{4C}-R^{5C} may also be substituted by halogens,
R⁴ has one of the definitions of R¹ or R⁴ corresponds to the formula (II):

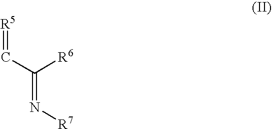

where
R⁵ together with the adjacent carbon atom, R³ and the nitrogen atom forms a pyridine ring which may be substituted by substituents selected independently from among C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, halogens,
the radicals R¹¹ are each, independently of one another, hydrogen, C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical, SiR¹²₃, where the organic radicals R¹¹ may also be substituted by halogens or nitrogen- and oxygen-comprising groups and two radicals R¹¹ may also be joined to form a five- or six-membered ring,
the radicals R¹² are each, independently of one another, hydrogen, C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical, where the organic radicals R¹² may also be substituted by halogens or nitrogen- and oxygen-comprising groups and two radicals R¹² may also be joined to form a five- or six-membered ring.

In preferred bidentate chelating ligands of the formula (I), R¹ and R⁴ are phenyl substituents which may, if desired, be substituted by branched and unbranched C₁₋₁₀-alkyl groups. The phenyl groups are preferably substituted in positions 2 and 6, particularly advantageously by i-propyl groups. R² and R³ are preferably C₁₋₁₀-alkyl groups, very particularly preferably methyl, or they together form an aromatic C₆₋₂₀ ring system, particularly preferably a naphthyl ring system.

Preference is also given to tridentate ligands of the formula (III)

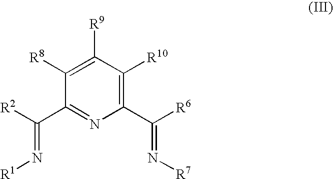

where the substituents have the following meanings:
R¹ and R⁷ are each, independently of one another, hydrogen, a straight-chain or branched C₁₋₁₀-alkyl which may be halogenated or perhalogenated, a C₃₋₁₀-cycloalkyl which may be substituted by a straight-chain or branched C₁₋₁₀-alkyl, or
a C₆₋₁₄-aryl which may be substituted by one or more substituents selected independently from among C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, halogen, NR¹¹₂, OR¹¹, SiR¹²₃, where the organic radicals R⁸-R¹⁰ may also be substituted by halogens and/or two vicinal substituents may also be joined to form a five-, six- or seven-membered ring and/or two vicinal substituents may be joined to form a five-, six- or seven-membered heterocycle comprising at least one atom from the group consisting of N, P, O and S,
R² and R⁶ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where the organic radicals R^{4C}-R^{5C} may also be substituted by halogens,
R⁸-R¹⁰ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where the organic radicals R⁸-R¹⁰ may also be substituted by halogens.

Examples of suitable ligands and processes for preparing them may be found, inter alia, in Britovsek et al., Chem. Commun., 1998, pp. 849-850. Further ligands are described in S. D. MeI, L. K. Johnson, M. Brookhart, Chem. Rev. 2000, 100, 1169-1203, and processes for preparing them are disclosed in WO96/023010.

Further ligand systems may be found in B. L. Small, M. Brookhart, J. Am. Chem. Soc. 1998, 120, 7143-7144, M. A. Esteruelas et al., Organometallics 2003, 22, 395-406, and B. L. Small et al., Macromolecules 2004, 37, 4375-4386.

Examples of particularly preferred ligands are:

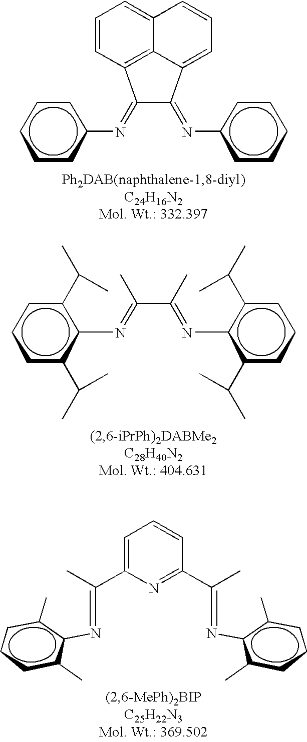

An activating compound is preferably used for activating the catalyst system.

Suitable activating compounds are, for example, compounds of the aluminoxane type.

As aluminoxanes, it is possible to use, for example, the compounds described in WO 00/31090. Particularly useful compounds of this type are open-chain or cyclic aluminoxane compounds of the formula (IV) or (V)

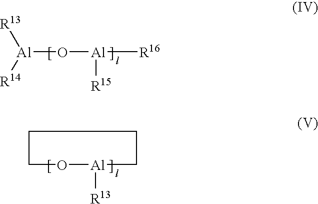

where R¹³-R¹⁶ are each, independently of one another, a C₁-C₆-alkyl group, preferably a methyl, ethyl, butyl or isobutyl group, and I is an integer from 1 to 40, preferably from 4 to 25.

A particularly suitable aluminoxane compound is methylaluminoxane.

These oligomeric aluminoxane compounds are usually prepared by controlled reaction of a solution of trialkylaluminum, in particular trimethylaluminum, with water. In general, the oligomeric aluminoxane compounds here are in the form of mixtures of both linear and cyclic chain molecules of various lengths, so that I is to be regarded as an average value. The aluminoxane compounds can also be present in admixture with other metal alkyls, usually aluminum alkyls. Aluminoxane preparations suitable as component (C) are commercially available.

Furthermore, modified aluminoxanes in which some of the hydrocarbon radicals have been replaced by hydrogen atoms or alkoxy, aryloxy, siloxy or amide radicals can be used in place of the aluminoxane compounds of the general formula (IV) or (V).

The polymerization can be carried out in a known manner in bulk, in suspension, in the gas phase or in a supercritical medium in the customary reactors used for the polymerization of olefins. It can be carried out batchwise or preferably continuously in one or more stages. High-pressure polymerization processes in tube reactors or autoclaves, solution processes, suspension processes, stirred gas-phase processes or gas-phase fluidized-bed processes are all possible.

Among the polymerization processes mentioned, gas-phase polymerization, in particular in gas-phase fluidized-bed reactors, solution polymerization and suspension polymerization, in particular in loop reactors and stirred tank reactors, are particularly preferred. The gas-phase polymerization can also be carried out in the condensed or supercondensed mode, in which part of the recycle gas is cooled to below the dew point and is recirculated as a two-phase mixture to the reactor. Furthermore, it is possible to use a multizone reactor in which two polymerization zones are linked to one another and the polymer is alternately passed through these two zones a number of times, with the two zones also being able to have different polymerization conditions. Such a reactor is described, for example, in WO 97/04015. The different or identical polymerization processes can also, if desired, be connected in series and thus form a polymerization cascade, as in, for example, the Hostalen® process. A parallel reactor arrangement of two or more identical or different processes is also possible. Furthermore, molar mass regulators, for example hydrogen, or customary additives such as antistatics can be concomitantly used in the polymerizations.

The polymerization can be stopped by addition of proton-active compounds such as mineral or organic acids, alcohols or water or mixtures of the compounds mentioned. Suitable organic acids are, for example, acetic acid or benzoic acid, and possible alcohols are, inter alia, methanol, ethanol or i-propanol.

The phyllosilicate dispersion is usually placed in the reaction vessel together with the ligand. However, the ligand can also be added at a later point in time. Furthermore, this dispersion comprising phyllosilicate and ligand can also be added to the reaction mixture after addition of the monomers or else continuously during the course of the reaction.

The polyolefin nanocomposites obtained by the process of the invention are used in the production of fibers, films and moldings.

The following examples illustrate the invention without restricting its scope.

### Abbreviations Used in the Table

AAS atomic absorption spectroscopy
BIP bisiminopyridyl
c_{cat.} [mmol Ni l⁻¹] metal concentration in the reaction mixture based on the amount of Ni in the MMT used
c_{cat.} [mmol M l⁻¹] metal concentration in the reaction mixture based on the amount of metal in the MMT used
DAB diazabutadiene
DB degree of branching
cat. catalyst
cat. descr. abbreviation for the catalyst. Metal contents in mmol of M (g of MMT)⁻¹, oxidation state, (reducing agent)
MAO methylaluminoxane
Mₙ number average molar mass
M_{w} weight average molar mass
PDI=M_{w}/Mₙ, polydispersity index
MMT montmorillonite
TEM transmission electron microscopy
TOF Turnover Frequency (activity in mol of ethene converted per mol of metal per hour)
m.p. melting point
ΔH enthalpy of fusion

The melting points and enthalpies of fusion are determined by means of DSC in accordance with ISO 11357-3:1999.

The molar masses M_{w}, Mₙ and the polydispersity index PDI=M_{w}/Mₙ are determined by means of GPC using a method based on DIN 55672. Calibration is effected by means of polystyrene standards.

The degree of branching DB indicates the number of branches per 1000 carbon atoms. The branches/1000 carbon atoms were determined by means of ¹³C-NMR as described by James. C. Randall, JMS-REV. Macromol. Chem. Phys., C29 (2&3), 201-317 (1989) and related to the total CH₃ group content/1000 carbon atoms including end groups. The side chains larger than CH₃/1000 carbon atoms are likewise determined in this way (excluding end groups).

### Production of the Sheel Silicate Catalysts

### EXAMPLE A

### Production of the Ni⁰-MMT Catalyst A

7.00 g of sodium bentonite (95% sodium montmorillonite (Na-MMT), 0.85 meq g⁻¹ cation exchange capacity) were heated under reflux in deionized water (700 ml) for 3 hours to obtain a stable Na-MMT suspension. 43.3 mg (0.17 mmol) of nickel sulfate hexahydrate were dissolved in deionized water (40 ml). The Na-MMT suspension (40 ml) was added to the solution at room temperature and the mixture was stirred for 25 hours. 0.2 ml (0.2 g, 4 mmol) of hydrazine hydroxide was subsequently added. Since no black coloration was observed after 20 hours, 0.10 g (2.6 mmol) of sodium borohydride in methanol (5 ml) was added. After stirring at room temperature for 48 hours, the mixture was centrifuged (4 h at 8000 rpm), the residue was redispersed in deionized water (40 ml) in ultrasonic bath and subsequently centrifuged again (2 h at 8000 rpm). The residue was dried overnight at 60° C. under reduced pressure and then pulverized in a mortar, shaken through a 150μ sieve and stored in air. The nickel content of the Ni⁰-MMT obtained in this way was determined by means of AAS measurements on the centrifugates and was 0.40 mmol of Ni per g of MMT.

### EXAMPLE B

### Production of the Ni⁰/Pd⁰-MMT Catalyst B

4.00 g of sodium bentonite (95% sodium montmorillonite (Na-MMT), 0.85 meq g⁻¹ cation exchange capacity) were heated in deionized water (400 ml) under reflux for 3 hours to obtain a stable Na-MMT suspension. 107.2 mg (0.41 mmol) of nickel sulfate hexahydrate and 12.7 mg (0.05 mmol) of palladium sulfate dihydrate were dissolved in deionized water (100 ml). The Na-MMT suspension (100 ml) which had previously been additionally homogenized by means of ultrasound (2×30 s, 60 W) was added to the solution at room temperature and the mixture was stirred at room temperature for 25 hours. 0.2 ml (0.2 g, 4 mmol) of hydrazine hydroxide was subsequently added and the mixture was stirred for 21 hours. It was then centrifuged (2 h at 8000 rpm), the residue was redispersed in deionized water (100 ml) with the aid of ultrasound (30 s, 80 W) and subsequently centrifuged again (2 h at 8000 rpm). The residue was dried overnight at 60° C. under reduced pressure and then pulverized in a mortar, shaken through a 150μ sieve and stored in air. The metal content of the Ni⁰/Pd⁰-MMT obtained in this way was determined by means of AAS measurements on the centrifugates and was 0.40 mmol of Ni and 0.05 mmol of Pd per g of MMT.

### EXAMPLE C

### Production of the Ni⁰/Pd⁰-MMT Catalyst C

20.04 g of sodium bentonite (95% sodium montmorillonite, Na-MMT, 0.85 meq g⁻¹ cation exchange capacity) were heated in distilled and air-free water (900 ml) under reflux for 1.5 hours to obtain a stable Na-MMT suspension. After cooling to room temperature, the suspension was made up to a total volume of 1000 ml with distilled and air-free water and additionally homogenized by means of ultrasound (3 min, 80 W). 107.7 mg (0.41 mmol) of nickel sulfate hexahydrate and 63.2 mg (0.26 mmol) of palladium sulfate dihydrate were dissolved in deionized water (150 ml). Na-MMT suspension (50 ml) was added to the solution at room temperature and the mixture was stirred at room temperature for 1 hour. 0.2 ml (0.2 g, 4 mmol) of hydrazine hydroxide was subsequently added and the mixture was stirred for 1 hour. It was then centrifuged (1 h at 14 000 rpm), the residue was redispersed in distilled and air-free water (200 ml) with the aid of ultrasound (30 s, 80 W) and subsequently centrifuged again (1 h at 14 000 rpm). After renewed redispersion/centrifugation, the residue was dried overnight at 60° C. under reduced pressure and then pulverized in a mortar, shaken through a 150μ sieve and stored under argon. The metal content of the Ni⁰/Pd⁰-MMT obtained in this way was determined by means of AAS measurements on the centrifugates and was 0.40 mmol of Ni and 0.25 mmol of Pd per g of MMT.

### EXAMPLE D

### Production of the Ni²⁺/Pd²⁺-MMT Catalyst D

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (1 min, 60 W). 106.0 mg (0.40 mmol) of nickel sulfate hexahydrate and 95.7 mg (0.40 mmol) of palladium sulfate dihydrate were dissolved in deionized water (100 ml). Na-MMT suspension (100 ml) was added to the solution at room temperature and the mixture was stirred at room temperature for 18 hours. It was then centrifuged (2 h at 14 000 rpm), the residue was redispersed in deionized water (200 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Ni²⁺/Pd²⁺-MMT obtained in this way was determined by means of AAS measurements on the sample digested in aqua regia and was 0.14 mmol of Ni and 0.14 mmol of Pd per g of MMT.

### EXAMPLE E

### Production of the Ni²⁺-MMT Catalyst E

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (2 min, 80 W). 308.6 mg (1.17 mmol) of nickel sulfate hexahydrate were dissolved in deionized water (230 ml). Na-MMT suspension (230 ml) was added to the solution at room temperature and the mixture was stirred at room temperature for 16 hours. It was then centrifuged (2 h at 14 000 rpm), the residue was redispersed in deionized water (460 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Ni²⁺-MMT obtained in this way was determined by means of AAS measurements on the sample digested in aqua regia and was 0.16 mmol of Ni per g of MMT.

### EXAMPLE F

### Production of the Ni²⁺-MMT Catalyst F

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (2 min, 80 W). 253.7 mg (1.16 mmol) of nickel dibromide were dissolved in deionized water (230 ml). Na-MMT suspension (230 ml) was added to the solution at room temperature and the mixture was stirred at room temperature for 16 hours. It was then centrifuged (2 h at 14 000 rpm), the residue was redispersed in deionized water (460 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Ni²⁺-MMT obtained in this way was determined by means of AAS measurements on the sample digested in aqua regia and was 0.16 mmol of Ni per g of MMT.

### EXAMPLE G

### Production of the Ni²⁺-MMT Catalyst G

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (2 min, 80 W). 606.2 mg (2.31 mmol) of nickel sulfate hexahydrate were dissolved in deionized water (230 ml). Na-MMT suspension (230 ml) was added to the solution at room temperature and the mixture was stirred at room temperature for 16 hours. It was then centrifuged (2 h at 14 000 rpm), the residue was redispersed in deionized water (460 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Ni²⁺-MMT obtained in this way was determined by means of AAS measurements on the sample digested in aqua regia and was 0.25 mmol of Ni per g of MMT.

### EXAMPLE H

### Production of the Ni²⁺-MMT Catalyst H

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (2 min, 80 W). 60.9 mg (0.23 mmol) of nickel sulfate hexahydrate were dissolved in deionized water (230 ml). Na-MMT suspension (230 ml) was added to the solution at room temperature and the mixture was stirred at room temperature for 16 hours. It was then centrifuged (2 h at 14 000 rpm), the residue was redispersed in deionized water (460 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Ni²⁺-MMT obtained in this way was determined by means of AAS measurements on the sample digested in aqua regia and was 0.03 mmol of Ni per g of MMT.

### EXAMPLE I

### Production of the Cr³⁺-MMT Catalyst I

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (1 min, 60 W). 414.0 mg (1.03 mmol) of chromium(III) nitrate nonahydrate were dissolved in deionized water (100 ml). Na-MMT suspension (100 ml) was added to the solution at room temperature and the mixture was stirred at room temperature for 18 hours. 0.5 ml (0.5 g, 10 mmol) of hydrazine hydroxide was subsequently added and the mixture was stirred for 16 hours. It was then centrifuged (2 h at 14 000 rpm), the residue was redispersed in deionized water (200 ml) by means of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Cr³⁺-MMT obtained in this way was determined by means of AAS measurements on the sample digested in aqua regia and was 0.44 mmol of Cr per g of MMT.

### EXAMPLE K

### Production of the Cr³⁺-MMT Catalyst K

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (1 min, 60 W). 158.6 mg (1.00 mmol) of chromium trichloride were suspended in deionized water (250 ml). Na-MMT suspension (250 ml) was added to the solution at room temperature and the mixture was stirred at room temperature for 15 hours. The MMT suspension/salt mixture was subsequently maintained at 50° C. in an ultrasonic bath for 4 hours. After stirring for 40 hours, the mixture was filtered, centrifuged (2 h at 14 000 rpm), the residue was redispersed in deionized water (500 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Cr³⁺-MMT obtained in this way was determined by means of AAS measurements on the sample digested in aqua regia and was 0.03 mmol of Cr per g of MMT.

### EXAMPLE L

### Production of the Fe³⁺-MMT Catalyst L

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (1 min, 60 W). 153.9 mg (1.01 mmol) of iron sulfate were dissolved in deionized water (100 ml). Na-MMT suspension (100 ml) was added to the solution at room temperature and the mixture was stirred at room temperature for 18 hours. 0.5 ml (0.5 g, 10 mmol) of hydrazine hydroxide was subsequently added and the mixture was stirred for 16 hours. It was then centrifuged (2 h at 14 000 rpm), the residue was redispersed in deionized water (200 ml) by means of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Fe³⁺-MMT obtained in this way was determined by means of AAS measurements on the sample digested in aqua regia and was 0.29 mmol of Fe per g of MMT.

### EXAMPLE M

### Production of the Cr³⁺-MMT Catalyst M

20.01 g of sodium bentonite (95% sodium montmorillonite, Na-MMT, 0.85 meq g⁻¹ cation exchange capacity) were heated in deionized water (900 ml) under reflux for 2 hours to obtain a stable Na-MMT suspension. After cooling to room temperature, the suspension was made up to a total volume of 1000 ml with deionized water and additionally homogenized by means of ultrasound (1 min, 60 W). 1005.0 mg (2.51 mmol) of chromium(III) nitrate nonahydrate were dissolved in deionized water (250 ml). Na-MMT suspension (250 ml) was added to the solution at room temperature and the mixture was stirred at room temperature for 15 hours. It was then centrifuged (2 h at 14 000 rpm), the residue was redispersed in deionized water (500 ml) with the aid of ultrasound (30 s, 80 W) and subsequently centrifuged again (2 h at 14 000 rpm). After renewed redispersion/centrifugation, the residue was dried overnight at 60° C. under reduced pressure and then pulverized in a mortar, shaken through a 150μ sieve and stored under argon. The metal content of the Cr³⁺-MMT obtained in this way was determined by means of AAS measurements on the sample digested in aqua regia and was 0.31 mmol of Cr per g of MMT.

### EXAMPLE N

### Production of the Cr³⁺-Nanofoam/Halloysite Catalyst N

A mechanically stirred emulsion of hexadecyltrimethylammonium bromide (4.60 g, 12.62 mmol), styrene (17.60 mL, 16.00 g, 153.61 mmol), and divinylbenzene (0.17 mL, 15.62 mg, 1.20 mmol) in 186 mL of deionized water was degassed under reduced pressure, placed under argon, and heated to 65° C. A solution of 2,2′-azobis(2-methylpropionamidine) dihydrochloride (210.00 mg, 0.77 mmol) dissolved in 10 mL of deionized water was added quickly and the mixture again was degassed under reduced pressure and placed under argon. The mixture was stirred at 65° C. for 20 hours to give a stable suspension of polystyrene spheres 40 nm in diameter. 4.00 g of sodium bentonite (95% sodium montmorillonite, Na-MMT, 0.85 meq g⁻¹ cation exchange capacity) was suspended in 80 mL of deionized water by means of ultrasound (120 s, 80 W). The suspension was added to the mixture of polystyrene spheres and rigorously stirred at 65° C. for 3 hours. To the clay-polystyrene suspension concentrated hydrochlorid acid (4.80 mL, 5.52 g, 55.91 mmol of hydrogenchloride) was added, followed by tetraethyl orthosilicate (28.00 mL, 26.15 g, 125.53 mmol). After 1 hour white precipitate appeared. The mixture was rigorously stirred at 65° C. for 20 hours, and then filtered and washed with 160 mL of deionized water. The yield after drying under reduced pressure at 60° C. for 12 hours were 32.2 g. The white solid was calcinated on air by using the following conditions: temperature increasing from 20 to 600° C. over 6 h and then holding at 600° C. for 6 h. The yield was 12.3 g nanofoam containing about 33 wt-% clay. The material was pulverized in a mortar and shaken through a 150 μm sieve prior to use. To a suspension of 5.00 g pulverized hybrid material in 250 mL of deionized water, 1.00 g (2:50 mmol) of chromium(III) nitrate nonahydrate dissolved in 250 mL of deionized water was added. After stirring for 12 hours at room temperature, the suspension was filtered and washed with 100 mL of deionized water. The residue was dried at 60° C. for 15 hours in vacuum and then stored under argon.

All experiments concerning the production of the polystyrene spheres and the nanofoam were accomplished on the basis of the Stucky's works (W. W. Lukens, Jr.; P. Yang; G. D. Stucky Chem. Mater. 2001, 13, 28-34).

### EXAMPLE O

### Production of the Cr³⁺-Nanofoam/Halloysite Catalyst O

Catalyst O was prepared analog to example N. Instead of sodium bentonite halloysite nanoclay (0.80 meq g⁻¹ cation exchange capacity) was used as the clay component. The yield after drying was 33.4 g and the residue after the calcinating process was 11.9 g (ca. 33 wt-% of halloysite).

### Ethene Polymerization

### EXAMPLES 01-04

### Example 04

48.2 mg (19.3 μmol Ni) of Ni⁰/Pd⁰-MMT catalyst C were placed in a 100 ml steel reactor with glass liner and the closed reactor was evacuated using an oil pump for 1 hour. A solution of 19.2 mg (57.8 μmol, 3 equivalents) of the diazabutadiene (DAB) ligand Ph₂DAB(naphthalene-1,8-diyl) in water- and air-free toluene (10 ml) was then introduced in a countercurrent of argon. After stirring for 30 minutes, 9.5 ml (4.97% by weight of Al in toluene, 800 equivalents of Al) of MAO solution was then added, likewise in a countercurrent of argon. After the reactor had been flushed three times with ethene, the reaction mixture was stirred at 1000 rpm under an ethene pressure of 5 MPa for 20 hours. The reaction mixture was subsequently introduced into a mixture of methanol (500 ml) and 10% strength hydrochloric acid (50 ml) and stirred overnight. It was then filtered and the polymer obtained was dried overnight at 60° C. under reduced pressure. This gave 5.88 g of a polyethene having a weight average molar mass M_{w}=834 700 g mol⁻¹ and a number average molar mass of Mₙ=143 000 g mol⁻¹ (productivity=260 g of PE (g of Ni h)⁻¹, TOF=540 h⁻¹).

Examples 01 to 03 were carried out in a manner analogous to this example 04 using the catalysts nickel acetate tetrahydrate (example 01), catalyst A (example O₂), catalyst B (example 03).

### EXAMPLES 05-07

### Example 07

All work was carried out under an argon atmosphere (Glove-Box, Schlenck technique). 89.3 mg (12.5 μmol of Ni) of Ni²⁺/Pd²⁺-MMT catalyst D together with 15.2 mg (37.6 μmol, 3 equivalents) of diazabutadiene (DAB) ligand (2,6-iPrPh)₂DABMe₂ were suspended or dissolved in water- and air-free toluene (10 ml). Water- and air-free toluene (15 ml) together with 5.0 ml (4.84% by weight of Al in toluene, 800 equivalents of Al) of MAO solution were placed in a 100 ml steel reactor with glass liner. The catalyst/ligand suspension was subsequently added and rinsed in with water- and air-free toluene (2×10 ml). After the reactor had been flushed three times with ethene, the mixture was stirred at 500 rpm under an ethene pressure of 5 MPa for 5 hours. The reaction mixture was subsequently introduced into a mixture of methanol (500 ml) and 10% strength hydrochloric acid (50 ml) and stirred overnight. The mixture was then filtered and the polymer obtained was dried overnight at 60° C. under reduced pressure. This gave 4.81 g of polyethene (productivity=1310 g of PE (g of Ni h)⁻¹, TOF=2730 h⁻¹).

Examples 05 and 06 were carried out in a manner analogous to this example 07 using different concentrations of catalyst C (see Table 1).

### EXAMPLES 08-10, 13-22

### Example 10

All work was carried out under an argon atmosphere (Glove-Box, Schlenck technique). 50.0 mg (8.0 μmol of Ni) of Ni²⁺-MMT catalyst E together with 9.7 mg (24.0 μmol, 3 equivalents) of diazabutadiene (DAB) ligand (2,6-iPrPh)₂DABMe₂ were suspended or dissolved in water- and air-free toluene (10 ml). Water- and air-free toluene (70 ml) together with 4.0 ml (4.84% by weight of Al in toluene, 800 equivalents of Al) of MAO solution were placed in a 100 ml steel reactor with glass liner. The catalyst/ligand suspension was subsequently added and rinsed in with water- and air-free toluene (2×10 ml). After the reactor had been flushed three times with ethene, the mixture was stirred at 500 rpm under an ethene pressure of 5 MPa for 5 hours. The reaction mixture was subsequently introduced into a mixture of methanol (500 ml) and 10% strength hydrochloric acid (50 ml) and stirred overnight. The mixture was then filtered and the polymer obtained was dried overnight at 60° C. under reduced pressure. This gave 0.56 g of a polyethene having a weight average molar mass of M_{w}=493 100 g mol⁻¹ and a number average molar mass of Mₙ=89 600 g mol⁻¹ (productivity=600 g of PE (g of Ni h)⁻¹, TOF=1250 h⁻¹).

Examples 08 and 09 and also Examples 13-22 were carried in a manner analogous to this example 10 using the various catalyst and catalyst concentrations indicated in table 1 (see table 1).

### COMPARATIVE EXAMPLES C11, C12, C23-C25

### Example C12

All work was carried out under an argon atmosphere (Glove Box, Schlenck technique). 5.3 mg (8.5 μmol of Ni) of the homogeneous catalyst [(2,6-iPrPh)₂DABMe₂]-NiBr₂ were dissolved in water- and air-free toluene (10 ml). Water- and air-free toluene (70 ml) together with 3.6 ml (5.67% by weight of Al in toluene, 800 equivalents of Al) of MAO solution were placed in a 100 ml steel reactor with glass liner. The catalyst solution was subsequently added and rinsed in with water- and air-free toluene (2×10 ml). After the reactor had been flushed three times with ethene, the mixture was stirred at 500 rpm under an ethene pressure of 0.7 MPa for 30 minutes. The reaction mixture was subsequently introduced into a mixture of methanol (500 ml) and 10% strength hydrochloric acid (50 ml) and stirred overnight. It was then filtered and the polymer obtained was dried overnight at 60° C. under reduced pressure. This gave 13.61 g of a polyethene having a weight average molar mass of M_{w}=540 400 g mol⁻¹ and a number average molar mass of Mₙ=177 400 g mol⁻¹ (productivity=54 510 g of PE (g of Ni h)⁻¹, TOF=114 050 h⁻¹).

Examples C11, C23-C25 were carried out analogously with the variations indicated in tables 2 and 3, with 510 mg of unmodified, dried Na⁺-MMT being added in Example C23 and 680 mg of an R₄N⁺-MMT exchanged with cetylpyridinium chloride, i.e. an organophilically modified R₄N⁺-MMT, being added in Example C24.

### EXAMPLES 27-32

### Example 32

All work was carried out under an argon atmosphere (Glove Box, Schlenck technique). 44.0 mg (13.6 μmol of Cr) of Cr³⁺-MMT catalyst M together with 15.1 mg (40.9 μmol, 3 equivalents) of bisiminopyridyl (BIP) ligand [(2,6-MePh)₂BIP]CrCl₃ were suspended or dissolved in water- and air-free toluene (10 ml). Water- and air-free toluene (70 ml) together with 4.4 ml (5.67% by weight of Al in toluene, 600 equivalents of Al) of MAO solution were placed in a 100 ml steel reactor with glass liner. The catalyst/ligand suspension was subsequently added and rinsed in with water- and air-free toluene (2×10 ml). After the reactor had been flushed three times with ethene, the mixture was stirred at 500 rpm under an ethene pressure of 4 MPa for 2 hours. The reaction mixture was subsequently introduced into a mixture of methanol (500 ml) and 10% strength hydrochloric acid (50 ml) and stirred overnight. It was then filtered and the polymer obtained was dried overnight at 60° C. under reduced pressure. This gave 5.28 g of a polyethene having a weight average molar mass of M_{w}=476 200 g mol⁻¹ and a number average molar mass of Mₙ=85 200 g mol⁻¹ (productivity=3720 g of PE (g of Ni h)⁻¹, TOF=6890 h⁻¹).

Examples 27-31 were carried out analogously with the variations indicated in table 3.

### EXAMPLES 33-35

### Example 35

All work was carried out under an argon atmosphere (Glove Box, Schlenck technique). 46.6 mg (14.4 μmol of Cr) of Cr³⁺-MMT catalyst M together with 16.0 mg (43.3 μmol, 3 equivalents) of bisiminopyridyl (BIP) ligand [(2,6-MePh)₂BIP]CrCl₃ were suspended or dissolved in water- and air-free toluene (10 ml). Water- and air-free toluene (70 ml) together with 4.6 ml (5.67% by weight of Al in toluene, 600 equivalents of Al) of MAO solution were placed in a 100 ml glass reactor and brought to 70° C. by means of a waterbath heated to 75° C. The catalyst/ligand suspension was subsequently added and rinsed in with water- and air-free toluene (2×10 ml). After the reactor had been flushed three times with ethene, the mixture was stirred at 500 rpm under an ethene pressure of 0.7 MPa for 2 hours. The reaction mixture was subsequently introduced into a mixture of methanol (500 ml) and 10% strength hydrochloric acid (50 ml) and stirred overnight. It was then filtered and the polymer obtained was dried overnight at 60° C. under reduced pressure. This gave 2.01 g of a polyethene having a weight average molar mass of M_{w}=352 600 g mol⁻¹ and a number average molar mass of Mₙ=68 500 g mol⁻¹ (productivity=1340 g of PE (g of Ni h)⁻¹, TOF=2480 h⁻¹).

Examples 33 and 34 were carried out analogously with the variations indicated in table 3.

Tables 1 to 3 show the reaction conditions together with the polymerization results and polymer characterization

### EXAMPLES 36, 37

### Example 36

All work was carried out under an argon atmosphere (Glove-Box, Schlenck technique). 150 mg of catalyst N were stirred in 1.5 mL of water- and air-free toluene and 0.5 mL of MAO (10-wt % in toluene) at room temperature for 45 min. Water- and air-free toluene (80 ml) together with 1.0 ml triisobutyl aluminum (1.0 M in hexanes) were placed in a 100 ml steel reactor with glass liner, which was evacuated using an oil pump for 1 hour at 80° C. prior to its use. The catalyst-suspension was subsequently added and rinsed with water- and air-free toluene (2×10 ml). After the reactor had been flushed three times with ethene, the mixture was stirred at 1000 rpm under an ethene pressure of 0.8 MPa and a temperature of 40° C. for 2 hours. The reaction mixture was subsequently introduced into a mixture of methanol (100 ml), 18% strength hydrochloric acid (10 ml), and 1 g of 2,6-di-tert-butyl-(4-methylphenol) and stirred for 2 hours. The mixture was then filtered and the polymer obtained was dried overnight at 60° C. under reduced pressure. This gave 7.80 g of polyethene having a weight average molar mass of M_{w}=2 070 100 g mol⁻¹ and a number average molar mass of Mₙ=690 300 g mol⁻¹ (productivity=52 g of PE (g supporting material)⁻¹).

Example 37 was carried out analogously with the variations indicated in table 4.

### EXAMPLES 38-41

### Example 38

All work was carried out under an argon atmosphere (Glove-Box, Schlenck technique). 100 mg of catalyst N were stirred in 1.5 mL of water- and air-free toluene and 0.5 mL of MAO (10-wt % in toluene) at room temperature for 45 min. After sedimentation, the supernatant liquid was removed with a pipette. The solid was then washed two times by slurring the particles in 5 mL of water- and air-free toluene. Afterwards 0.05 mg (0.10 μmmol) of 2,6-bis[1-(2-methylphenylimino)ethyl]pyridineiron(II) chloride catalyst dissolved in 0.37 mL of toluene and 0.13 mL of TMA-solution (0.02 M in toluene) were added. The mixture was stirred for 5 min. After sedimentation, the supernatant liquid was removed with a pipette. Water- and air-free n-heptane (80 mL) together with 1.0 mL triisobutyl aluminum (1.0 M in hexanes) were placed in a 100 ml steel reactor with glass liner, which was evacuated using an oil pump for 1 hour at 80° C. prior to its use. The catalyst-suspension was subsequently added and rinsed with water- and air-free n-heptane (2×10 ml). After the reactor had been flushed three times with ethene, the mixture was stirred at 1000 rpm under an ethene pressure of 0.8 MPa and a temperature of 40° C. for 2 hours. The reaction mixture was subsequently introduced into a mixture of n-butanol (20 ml), methanol (80 mL), 18% strength hydrochloric acid (10 ml), and 1 g of 2,6-di-tertbutyl-(4-methylphenol) and stirred for 2 hours. The mixture was then filtered and the polymer obtained was dried overnight at 60° C. under reduced pressure. This gave 8.16 g of polyethene having a weight average molar mass of M_{w}=412 300 g mol⁻¹ and a number average molar mass of Mₙ=28 100 g mol⁻¹ (productivity=82 g of PE (g supporting material)⁻¹).

Examples 39-41 were carried out analogously with the variations indicated in table 4.

The following tables show the reaction conditions together with the polymerization results and polymer characterization

TABLE 1
Reaction conditions and results of the polymerizations using reduced and unreduced Ni/Pd-MMT.

| | | | C_{cat.} | | Productivity | | DB per | | | | | |
|---|---|---|---|---|---|---|---|---|---|---|---|---|
| Exam- | | | [mmol | Pressure | [g of PE | TOF | 1000 C | M.p. | ΔH | M_{w} | Mₙ | |
| ple | Cat. | Cat. descr. | Ni I⁻¹] | p [MPa] | (g of Ni h)⁻¹] | [h⁻¹] | atoms | [° C.] | [J g⁻¹] | [g mol⁻¹] | [g mol⁻¹] | PDI |
| 01¹⁾ | Ni(OAc)₂ | Nickel acetate²⁾ | 1.97 | 5 | 20 | 40 | 8 | 126 | 77 | 10 40 300 | 143 400 | 7.3 |
| 02¹⁾ | A | 0.40 Ni⁰ (NaBH₄) | 0.97 | 5 | 90 | 180 | 10 | 131 | 121 | 612 000 | 105 000 | 5.8 |
| 03¹⁾ | B | 0.40 Ni⁰ 0.05 Pd⁰ | 1.00 | 5 | 220 | 450 | 94 | 124 | 121 | 737 900 | 136 300 | 5.4 |
| 04¹⁾ | C | 0.40 Ni⁰ 0.25 Pd⁰ | 0.96 | 5 | 260 | 540 | 31 | 121 | 96 | 834 700 | 143 000 | 5.8 |
| 05 | C | 0.40 Ni⁰ 0.25 Pd⁰ | 0.70 | 5 | 410 | 870 | — | — | — | — | — | — |
| 06 | C | 0.40 Ni⁰ 0.25 Pd⁰ | 0.61 | 5 | 200 | 410 | — | — | — | — | — | — |
| 07 | D | 0.14 Ni²⁺ 0.14 Pd²⁺ | 0.25 | 5 | 1310 | 2730 | — | — | — | — | — | — |
| 08 | D | 0.14 Ni²⁺ 0.14 Pd²⁺ | 0.06 | 4 | 200 | 430 | 15 | 135 | 220 | — | — | — |
| 09 | D | 0.14 Ni²⁺ 0.14 Pd²⁺ | 0.08 | 0.7 | 90 | 290 | 21 | 116 | 85 | 606 000 | 128 100 | 4.7 |
| 10 | E | 0.16 Ni²⁺ | 0.08 | 5 | 600 | 1250 | 12 | 125 | 111 | 493 100 | 89 600 | 5.5 |

¹⁾Use of Ph₂DAB(naphthalene-1,8-diyl) as ligand
²⁾Nickel acetate tetrahydrate

TABLE 2
Reaction conditions and results of the polymerizations using unreduced Ni²⁺-MMT.

| | | | C_{cat.} | | Productivity | | DB per | | | | | |
|---|---|---|---|---|---|---|---|---|---|---|---|---|
| Exam- | | | [mmol | Pressure | [g of PE | TOF | 1000 C | M.p. | ΔH | M_{w} | Mn | |
| ple | Cat. | Cat. descr. | ML⁻¹] | p [MPa] | (g of M h)⁻¹] | [h⁻¹] | atoms | [° C.] | [Jg⁻¹] | [g mol⁻¹] | [g mol⁻¹] | PDI |
| C11 | [(2,6-iPrPh)₂DABMe₂]PdMeCl | | 0.07 | 0.7 | 320 | 1230 | 139 | −36 | 6 | 728 100 | 155 200 | 4.7 |
| C12 | [(2,6-iPrPh)₂DABMe₂]NiBr₂ | | 0.09 | 0.7 | 54 510 | 1140 50 | 95 | — | — | 540 400 | 177 400 | 3.0 |
| 13 | NiBr₂ | nickel dibromide | 0.19 | 0.7 | 20 | 40 | 43 | 79 | — | 294 900 | 144 500 | 2.0 |
| 14 | E | 0.16 Ni²⁺ | 0.03 | 0.7 | 40 | 80 | — | 121 | 197 | — | — | — |
| 15 | E | 0.16 Ni²⁺ | 0.03 | 0.7 | 70 | 150 | 26 | 116 | 111 | — | — | — |
| | | (6 h polym. time) | | | | | | | | | | |
| 16 | E | 0.16 Ni²⁺ | 0.30 | 0.7 | 600 | 1250 | 24 | 112 | — | — | — | — |
| 17 | E | 0.16 Ni²⁺ | 0.10 | 0.7 | 250 | 530 | 26 | 113 | 101 | 783 300 | 109 400 | 7.2 |
| 18 | E | 0.16 Ni²⁺ | 0.08 | 0.7 | 230 | 470 | — | 113 | 98 | — | — | — |
| 19 | F | 0.16 Ni²⁺ (from NiBr₂) | 0.11 | 0.7 | 220 | 450 | 26 | 112 | | 582 600 | 90 100 | 6.5 |
| 20 | G | 0.25 Ni²⁺ | 0.08 | 0.7 | 250 | 510 | 20 | 115 | 104 | — | — | — |
| 21 | H | 0.03 Ni²⁺ | 0.08 | 0.7 | 200 | 410 | 76 | — | — | — | — | — |
| 22 | E | 0.16 Ni²⁺ | 0.09 | 4 | 570 | 1200 | 12 | 124 | 129 | 348 300 | 86 600 | 4.0 |
| 10 | E | 0.16 Ni²⁺ | 0.08 | 5 | 600 | 1250 | 12 | 125 | 121 | 493 100 | 89 600 | 5.5 |

| | | | | | | | | | | | |
|---|---|---|---|---|---|---|---|---|---|---|---|
| C23 | No. 12 + Na⁺-MMT | 0.12 | 0.7 | 45950 | 96140 | 101 | — | — | 690 000 | 193 300 | 3.6 |
| C24 | No. 12 + R₄N⁺-MMT | 0.12 | 0.7 | 7670 | 16050 | 44 | 92 | 36 | 944 100 | 143 000 | 6.6 |

TABLE 3
Reaction conditions and results of the polymerizations
using Cr³⁺- and Fe³⁺-MMT.

| | | | C_{cat.} | | | Productivity |
|---|---|---|---|---|---|---|
| Exam- | | | [mmol | Pressure | | [g of PE |
| ple | Cat. | Cat. descr. | M L⁻¹] | p [MPa] | T [° C.] | (g M h)⁻¹] |
| C25 | [(2,6-MePh)₂BIP]CrCl₃ | | 0.08 | 0.7 | 25 | 50 470 |
| 26 | CrCl₃ | chromium | 0.09 | 4 | 25 | 20 |
| | | trichloride 0.44 Cr³⁺ | | | | |
| 27 | I | (+N₂H₅OH) | 0.19 | 4 | 25 | 420 |
| | | 0.05 Cr³⁺ | | | | |
| 28 | K | (from CrCl₃) | 0.10 | 4 | 25 | 680 |
| 29 | L | 0.29 Fe³⁺ | 0.12 | 0.7 | 25 | 130 |
| 30 | M | 0.31 Cr³⁺ | 0.15 | 6 | 25 | 1820 |
| 31 | M | 0.31 Cr³⁺ | 0.17 | 5 | 25 | 6840 |
| 32 | M | 0.31 Cr³⁺ | 0.14 | 4 | 25 | 3720 |
| 33 | M | 0.31 Cr³⁺ | 0.14 | 0.7 | 25 | 980 |
| 34 | M | 0.31 Cr³⁺ | 0.14 | 0.7 | 50 | 2910 |
| 35 | M | 0.31 Cr³⁺ | 0.14 | 0.7 | 70 | 1340 |

| Exam- | TOF | M.p. | ΔH | M_{w} | Mₙ | |
|---|---|---|---|---|---|---|
| ple | [h⁻¹] | [° C.] | [J g⁻¹l | [g mol⁻¹] | [g mol⁻¹] | PDI |
| C25 | 93 550 | 99-110 | | 415 700 | 119 400 | 3.5 |
| 26 | 30 | 129 | 213 | 455 700 | 60 600 | 7.5 |
| 27 | 770 | 135 | 205 | — | — | — |
| | | | | | | — |
| 28 | 1250 | 132 | 152 | — | — | 4.2 |
| 29 | 240 | — | — | 455 700 | 108 200 | |
| 30 | 3370 | 135 | 210 | 478 800 | 115 800 | 4.1 |
| 31 | 12 680 | 135 | 210 | 348 800 | 83 200 | 4.2 |
| 32 | 6890 | 135 | 208 | 476 200 | 85 200 | 5.6 |
| 33 | 1810 | 135 | 206 | 522 700 | 119 900 | 4.4 |
| 34 | 5400 | 135 | 220 | 412 100 | 74 300 | 5.5 |
| 35 | 2480 | 134 | 210 | 352 600 | 68 500 | 5.1 |

TABLE 4
Reaction conditions and results of the polymerizations using Cr³⁺-Clay/Nanofoam and Fe-catalyst.

| | | | | | | Productivity | | | |
|---|---|---|---|---|---|---|---|---|---|
| Exam- | | | n_{Fe-catalyst} | Pressure | | [g of PE | M_{w} | Mn | |
| ple | Cat. | Cat. descr. | [μmol] | p [MPa] | T [° C.] | (g support)⁻¹] | [g mol⁻¹] | [g mol⁻¹] | PDI |
| 36 | N | Cr³⁺/MMT/NF | — | 0.8 | 40 | 52 | 2 070 100 | 690 300 | 3.0 |
| 37 | O | Cr³⁺/Hal/NF | — | 0.8 | 40 | 58 | 2 350 500 | 728 500 | 3.2 |
| 38 | N | Cr³⁺/MMT/NF + Fe | 0.10 | 0.8 | 40 | 82 | 412 300 | 28 100 | 14.7 |
| 39 | N | Cr³⁺/MMT/NF + Fe | 0.20 | 0.8 | 40 | 95 | 339 900 | 26 400 | 12.9 |
| 40 | O | Cr³⁺/Hal/NF + Fe | 0.10 | 0.8 | 40 | 68 | 470 200 | 25 800 | 18.2 |
| 41 | O | Cr³⁺/Hal/NF + Fe | 0.20 | 0.8 | 40 | 80 | 351 500 | 24 100 | 14.6 |

1-11. (canceled)

12. A catalyst system for the polymerization of olefins, comprising:
a) a support in which cations or uncharged metal atoms of one or more transition metals of group 4, 5, 6, 7, 8, 9 or 10 of the Periodic Table of the Elements are distributed; and
b) one or more separately added ligands which can form a coordinate or covalent bond with the transition metals.

13. The catalyst system according to claim 12, which further comprises an activating compound.

14. The catalyst system according to claim 13, wherein the activating compound is an open-chain or cyclic aluminoxane compound of the general formula (IV) or (V) 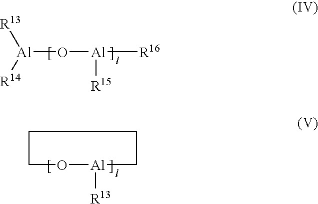
where R¹³-R¹⁶ are each, independently of one another, a C₁-C₆-alkyl group, preferably a methyl, ethyl, butyl or isobutyl group, and I is an integer from 1 to 40.

15. The catalyst system according to claim 12, wherein the support is a phylloclay mineral whose ions have been replaced by cations of one or more transition metals of group 4, 5, 6, 7, 8, 9 or 10 of the Periodic Table of the Elements which have optionally been reduced.

16. The catalyst system according to claim 15, wherein the phylloclay mineral is a phyllosilicate selected from among montmorillonite, saponite, beidelite, nontronite, hevtorite, sauconite and stevensite, bentonite, vermiculite and halloysite.

17. The catalyst system according to claim 12, wherein the transition metals present in the support are transition metals of groups 6, 8 and 10 of the Periodic Table.

18. The catalyst system according to claim 17, wherein the transition metal is selected from Cr³⁺, Fe³⁺, Ni²⁺, Ni⁰, Cr⁰, Fe⁰, the combination of Ni²⁺ and Pd²⁺, and the combination of Ni⁰ and Pd⁰.

19. The catalyst according to claim 12, wherein the ligand can form a coordinate bond with the transition metal or metals.

20. The catalyst system according to claim 19, wherein the ligand corresponds to the formula (I): 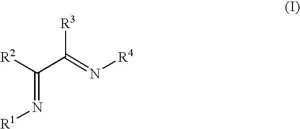
where
R¹ and R⁴ are each, independently of one another, hydrogen, a straight-chain or branched C₁₋₁₀-alkyl which may be halogenated or perhalogenated, a C₃₋₁₀-cycloalkyl which may be substituted by a straight-chain or branched C₁₋₁₀-alkyl or is C₆₋₁₄-aryl which may be substituted by one or more substituents selected independently from among C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, halogen, NR¹¹₂, OR¹¹, SiR¹²₃ and halogens, where two vicinal substituents may also be joined to form a five-, six- or seven-membered ring and two vicinal substituents may also be joined to form a five-, six- or seven-membered heterocycle comprising at least one atom from the group consisting of N, P, O and S,
R² and R³ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where R² and R³ may also be substituted by halogens,
R¹¹ and R¹² are each, independently of one another, hydrogen, C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical, where R¹¹ and R¹² may also be substituted by halogens or nitrogen- and oxygen-comprising groups, and R¹¹ and R¹² may also be joined to form a five- or six-membered ring.

21. The catalyst system according to claim 19, wherein the ligand is a tridentate ligand of the formula (III) 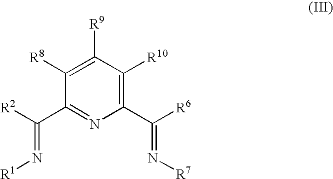
where the substituents have the following meanings:
R¹ and R⁷ are each, independently of one another, hydrogen, a straight-chain or branched C₁₋₁₀-alkyl which may be halogenated or perhalogenated, a C₃₋₁₀-cycloalkyl which may be substituted by a straight-chain or branched C₁₋₁₀-alkyl, or a C₆₋₁₄-aryl which may be substituted by one or more substituents selected independently from among C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, halogen, NR¹¹₂, OR¹¹, SiR¹²₃, where R¹ and R⁷ may also be substituted by halogens and/or two vicinal substituents may also be joined to form a five-, six- or seven-membered ring and/or two vicinal substituents may be joined to form a five-, six- or seven-membered heterocycle comprising at least one atom from the group consisting of N, P, O and S,
R² and R⁶ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where R² and R⁶ may also be substituted by halogens,
R⁸-R¹⁰ are each, independently of one another, hydrogen, C₁-C₂₂-alkyl, C₂-C₂₂-alkenyl, C₆-C₂₂-aryl, alkylaryl having from 1 to 10 carbon atoms in the alkyl radical and 6-20 carbon atoms in the aryl radical, NR¹¹₂, SiR¹²₃, where R⁸-R¹⁰ may also be substituted by halogens, and
R¹¹ and R¹² are each, independently of one another, hydrogen, C₁-C₂₀-alkyl, C₂-C₂₀-alkenyl, C₆-C₂₀-aryl, alkylaryl having from 1 to 10 carbon atoms in the alkyl radical and 6-20 carbon atoms in the aryl radical, where R¹¹ and R¹² may also be substituted by halogens or nitrogen- and oxygen-comprising groups, and R¹¹ and R¹² may also be joined to form a five- or six-membered ring.

22. A process for producing catalyst systems, which comprises the steps:
a) replacing metal ions in a support comprising exchangeable metal ions by metal ions of one or more transition metals of group 4, 5, 6, 7, 8, 9 or of the Periodic Table of the Elements by ion exchange;
b) optionally, reducing the transition metal ions; and
c) adding one or more ligands which can form a coordinate or covalent bond with the transition metal or metals.

23. A process which comprises polymerizing an α-olefin using a catalyst system according to claim 12.
